(19) United States
(12) Patent Application Publication
(10) Pub. No.: US 2008/0320293 A1
(43) Pub. Date: Dec. 25, 2008

(54) CONFIGURABLE PROCESSING CORE

(75) Inventors: Ahmadreza (Reza) Rofougaran, Newport Coast, CA (US); Timothy W. Markison, Lahaina, HI (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/202,259

(22) Filed: Aug. 30, 2008

Related U.S. Application Data
(63) Continuation-in-part of application No. 12/026,681, filed on Feb. 6, 2008.
Application No. 12/026,681 is a continuation-in-part of application No. 11/700,285, filed on Jan. 31, 2007.

(51) Int. Cl. G06F 15/177; G06F 9/30

(52) U.S. Cl. 713/1; 712/28; 712/E09.001

(57) ABSTRACT

A configurable processing core includes a configuration module and a plurality of functional blocks, each including a millimeter wave (MMW) transceiver. The configuration module is operable to determine configuration of at least some of the plurality of functional blocks based on at least one instruction of an algorithm, generate a configuration signal in accordance with the determined configuration, and transmit the configuration signal to the at least some of the plurality of functional blocks via the MMW transceivers. The at least some of the plurality of functional blocks are operable to configure in accordance with the configuration signal to support execution of the at least one instruction.

This patent application is claiming priority under 35 USC § 120 as a continuation in part patent application of co-pending patent application entitled COMPUTING DEVICE WITH HANDHELD AND EXTENDED COMPUTING UNITS, having a filing date of Feb. 6, 2008, and a Ser. No. 12/026,681 and of co-pending patent application entitled RF BUS CONTROLLER, having a filing date of Jan. 31, 2007, and a Ser. No. 11/700,285.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to computing devices and more particularly to components of such computing devices.

2. Description of Related Art

Communication systems are known to support wireless and wire lined communications between wireless and/or wire lined communication devices. Such communication systems range from national and/or international cellular telephone systems to the Internet to point-to-point in-home wireless or wired networks. The wireless and/or wire lined communication devices may be personal computers, laptop computers, personal digital assistants (PDA), cellular telephones, personal digital video players, personal digital audio players, global positioning system (GPS) receivers, video game consoles, entertainment devices, etc.

Many of the communication devices include a similar basic architecture: that being a processing core, memory, and peripheral devices. The memory stores operating instructions that the processing core uses to generate data, which may also be stored in the memory. The peripheral devices allow a user of the communication device to direct the processing core as to which programs and hence which operating instructions to execute, to enter data, etc. and to see the resulting data. For example, a cellular telephone includes a keypad, a display, a microphone and a speaker for such functions.

The processing core typically includes one or more digital signal processors (DSP) and/or one or more microprocessors. The basic architecture of a DSP and of a microprocessor is known to include an instruction cache, a data cache, and an execution unit (e.g., a multiply-accumulator for a DSP and an arithmetic unit for a microprocessor). While DSPs and microprocessors are programmable to execute a wide variety of algorithms, their configuration is fixed and hard wired. In addition, a DSP and/or a microprocessor may be implemented as a single pipelined device or a parallel pipelined device, but is generally not interchangeable.

As integrated circuit technology advances, the basic architecture of a DSP and/or microprocessor is increasing in complexity, capabilities, and size reduction. However, communication within these components is done using traces (e.g., on an IC and/or on a PCB), which requires drivers to drive the lines. As is known, the transferring of data via the traces and drivers consumes a significant amount of power, which produces heat. With many DSP and/or microprocessor architectures, heat dissipation is a critical issue.

Therefore, a need exists for a configurable processing core that reduces power consumption and provides flexibility in implementation.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a configurable processing core in accordance with the invention;

FIGS. 2-4 are logic diagrams of an embodiment of configuring a configurable processing core in accordance with the invention;

FIG. 5 is a schematic block diagram of another embodiment of a configurable processing core in accordance with the invention;

FIG. 6 is a schematic block diagram of another embodiment of a configurable processing core in accordance with the invention;

FIG. 7 is a schematic block diagram of another embodiment of a configurable processing core in accordance with the invention;

FIG. 8 is a schematic block diagram of another embodiment of a configurable processing core in accordance with the invention;

FIG. 9 is a schematic block diagram of another embodiment of a configurable processing core in accordance with the invention;

FIG. 10 is a schematic block diagram of another embodiment of a configurable processing core in accordance with the invention;

FIG. 11 is a schematic block diagram of another embodiment of a configurable processing core in accordance with the invention; and

FIG. 12 is a schematic block diagram of another embodiment of a configurable processing core in accordance with the invention.

### DETAILED DESCRIPTION OF THE INVENTION

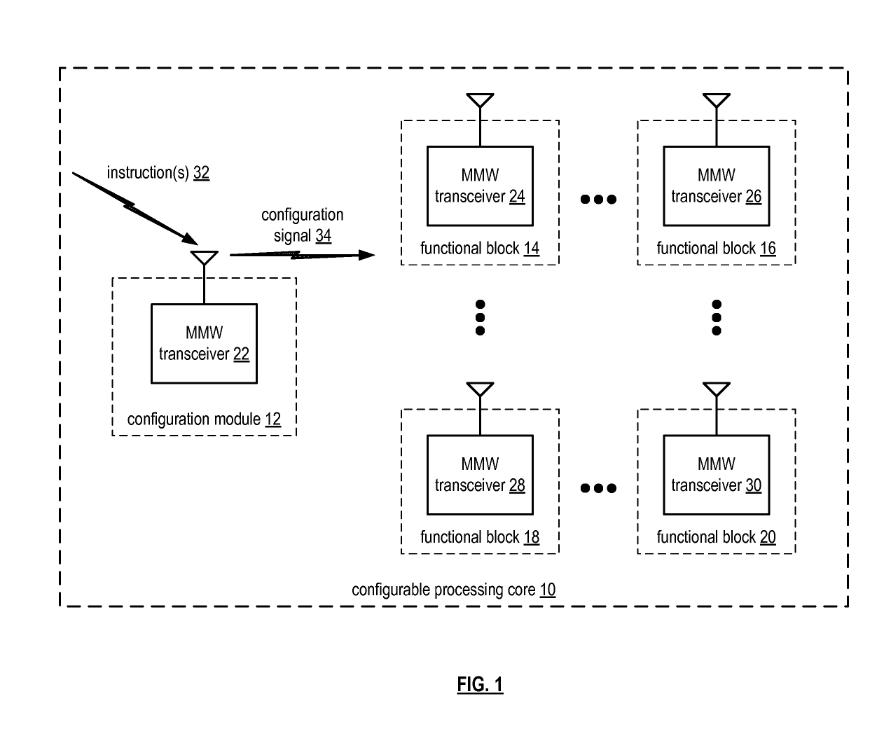

FIG. 1 is a schematic block diagram of an embodiment of a configurable processing core 10 that includes a configuration module 12 and a plurality of functional blocks 14-20, each of which includes a millimeter wave (MMW) transceiver 22-30. The plurality of functional blocks 14-20 may include one or more floating point adders, one or more floating point multipliers, one or more registers, one or more integer adders, one or more integer multipliers, one or more shift registers, one or more accumulators, one or more logic units, and/or one or more delays.

Each of the MMW transceivers 22-30 may include a baseband processing module, a receiver section, and a transmitter section. The transmitter and receiver sections may share one or more antennas or each may have its own one or more antennas. The baseband processing module converts outbound data (e.g., an instruction and/or data) into an outbound symbol stream in accordance with a data modulation scheme and a channel usage scheme. The data modulation scheme may be binary phase shift keying (BPSK), quadrature phase shift keying (QPSK), frequency shift keying (FSK), minimum shift keying (MSK), amplitude shift keying (ASK), quadrature amplitude modulation (QAM), a combination thereof, and/or variations thereof. The channel usage scheme may be time division multiple access (TDMA), frequency divisional multiple access (FDMA), code division multiple access (CDMA), orthogonal frequency division multiplexing (OFDM), a combination thereof, and/or variations thereof. In addition, the baseband processing module may also utilize a scrambling scheme, an encoding scheme, a data puncture scheme, an interleaving scheme, space-time-frequency encoding, a beamforming scheme, a frequency to time domain conversion, and/or a combination thereof to produce the outbound symbol stream.

The transmitter section converts the outbound symbol stream into an outbound RF signal that has a carrier frequency within a given frequency band (e.g., 57-66 GHz, or any other in the microwave frequency range of 3-300 GHz.). In an embodiment, this may be done by mixing the outbound symbol stream with a local oscillation to produce an up-converted signal. One or more power amplifiers and/or power amplifier drivers amplifies the up-converted signal, which may be RF bandpass filtered, to produce the outbound RF signal. In another embodiment, the transmitter section includes an oscillator that produces an oscillation. The outbound symbol stream provides phase information (e.g., +/− Δθ [phase shift] and/or θ(t) [phase modulation]) that adjusts the phase of the oscillation to produce a phase adjusted RF signal, which is transmitted as the outbound RF signal. In another embodiment, the outbound symbol stream includes amplitude information (e.g., A(t) [amplitude modulation]), which is used to adjust the amplitude of the phase adjusted RF signal to produce the outbound RF signal.

In yet another embodiment, the transmitter section includes an oscillator that produces an oscillation. The outbound symbol provides frequency information (e.g., +/− Δf [frequency shift] and/or f(t) [frequency modulation]) that adjusts the frequency of the oscillation to produce a frequency adjusted RF signal, which is transmitted as the outbound RF signal. In another embodiment, the outbound symbol stream includes amplitude information, which is used to adjust the amplitude of the frequency adjusted RF signal to produce the outbound RF signal. In a further embodiment, the transmitter section includes an oscillator that produces an oscillation. The outbound symbol provides amplitude information (e.g., +/− ΔA [amplitude shift] and/or A(t) [amplitude modulation) that adjusts the amplitude of the oscillation to produce the outbound RF signal.

The receiver section amplifies an inbound RF signal to produce an amplified inbound RF signal. The receiver section may then mix in-phase (I) and quadrature (Q) components of the amplified inbound RF signal with in-phase and quadrature components of a local oscillation to produce a mixed I signal and a mixed Q signal. The mixed I and Q signals are combined to produce an inbound symbol stream. In this embodiment, the inbound symbol may include phase information (e.g., +/− Δθ [phase shift] and/or θ(t) [phase modulation]) and/or frequency information (e.g., +/− Δf [frequency shift] and/or f(t) [frequency modulation]). In another embodiment and/or in furtherance of the preceding embodiment, the inbound RF signal includes amplitude information (e.g., +/− ΔA [amplitude shift] and/or A(t) [amplitude modulation]). To recover the amplitude information, the receiver section includes an amplitude detector such as an envelope detector, a low pass filter, etc.

The baseband processing module converts the inbound symbol stream into inbound data (e.g., an instruction and/or data) in accordance with the data modulation scheme and the channel usage scheme. In addition to demodulating the inbound symbol stream, the baseband processing module may also utilize a descrambling scheme, a decoding scheme, a data de-puncture scheme, a de-interleaving scheme, space-time-frequency decoding, a time to frequency domain conversion, and/or a combination thereof to produce the inbound data.

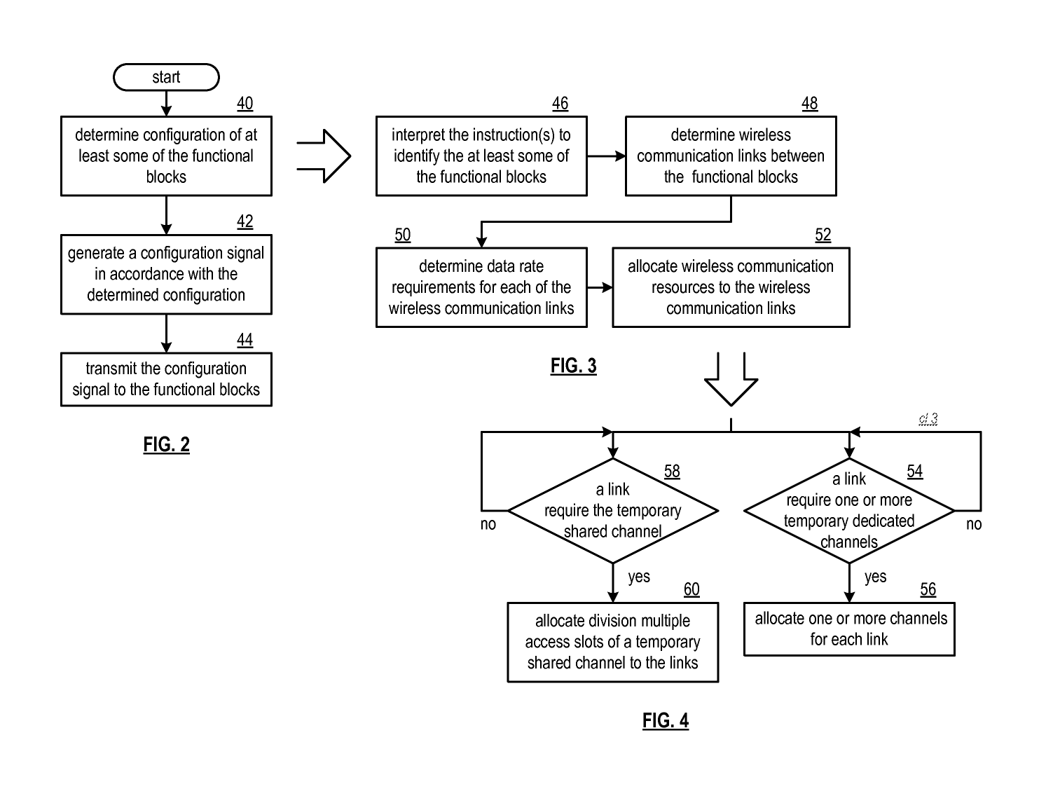

In this embodiment, the configuration module 12 performs the method of FIG. 2 to configure, via a configuration signal 34, at least some of the plurality of functional blocks 14-20 to execute one or more instructions 32 of an algorithm. The method of FIG. 2 begins at step 40 where the configuration module 12 determines configuration of at least some of the plurality of functional blocks based on at least one instruction 32 of an algorithm. An embodiment of this step will be described in greater detail with reference to FIG. 3.

The method continues at step 42 where the configuration module 12 generates a configuration signal 34 in accordance with the determined configuration. The configuration signal 34 indicates which of the plurality of functional blocks 14-20 are needed for the instruction(s) 32, the needed wireless links between the functional blocks, allocation of wireless communication resources (e.g., frequency band, channels within the frequency band, time, code, and/or frequency slots of a channel, etc.) for each wireless link, and synchronization signaling to insure that the instruction(s) is/are executed in a desired manner. Note that the determining of the configuration and the content of the configuration signal may be done by accessing a look up table, by receiving the configuration within the instruction, and/or by an on-the-fly determination process.

The method continues at step 44 where the configuration module 12 transmits the configuration signal 34 to the at least some of the plurality of functional blocks 14-20 via the configuration MMW transceiver 22 and the functional MMW transceivers 22-30 associated with the at least some of the plurality of functional blocks 14-20. The conveyance of the configuration signal 34 may be done via a default channel utilization scheme (e.g., time division multiple access (TDMA), frequency division multiple access (FDMA), code division multiple access (CDMA), orthogonal frequency division multiplexing (OFDM), etc.) and a default data modulation scheme (e.g., binary phase shift keying, quadrature phase shift keying, frequency shift keying, minimum shift keying, quadrature amplitude modulation, frequency modulation, amplitude modulation, amplitude shift keying, etc.). Alternatively, the configuration signal 34 may be transmitted to the function MMW transceivers 22-30 via a dedicate control channel.

FIG. 3 is a logic diagram of an embodiment of determining the configuration as previously described in step 40 of FIG. 2. This embodiment begins at step 46 where the configuration module 12 interprets the at least one instruction 32 to identify the at least some of the plurality of functional blocks 14-20. The interpreting includes identifying the instruction from an instruction set, which may be a conventional instruction set (reduced instruction set computing—RISC, advanced RISC machine—ARM, etc.) or a unique instruction set for the configurable processing core 10. The instruction set may include instructions to move data, to compute data, and/or to affect process flow. The instruction set may further include complex instructions such as simultaneous saving of many registers on a stack, moving large blocks of memory, complex mathematical functions (trigonometry operations, etc.) floating point arithmetic, etc.

The move instructions may include setting a register to a constant, moving data from memory to a register or vice versa, read data from a device, write data to a device, etc. The computing instruction may include basic mathematics (add, subtract, multiply, etc.), logic operations (AND, OR, NAND, etc.), comparisons, etc. The instructions affecting program flow may include conditional jumps functions, unconditional jump functions, etc.

The method continues at step 48 where the configuration module 12 determines wireless communication links between the at least some of the plurality of functional blocks. For example, the configuration module 12 determines which functional blocks will be need to communicate with each other (e.g., a register to an adder) and establishes a need for wireless communication links therebetween. The method continues at step 50 where the configuration module 12 determines data rate requirements for each of the wireless communication links. For example, the data rate requirements may be for short bursts of high rate data, short bursts of low rate data, continuous or near continuous high rate data, and/or continuous or near continuous low rate data.

The method then continues at step 52 where the configuration module 12 allocates, when available, wireless communication resources to the wireless communication links based on the data rate requirements. This may be done as described in the example method of FIG. 4.

The method of FIG. 4 begins at steps 54 and 58. At step 58, the configuration module 12 determines whether one or more of the wireless communication links requires one or more temporary dedicated channels of a plurality of channels. For example, when the data rate is a continuous or near continuous high or low rate data, then the configuration module 12 will allocate one or more channels to each of the communication links. If the one or more of the wireless communication links requires the one or more temporary dedicated channels, the method continues at step 56 where the configuration module 12 allocates one or more of a plurality of channels for each wireless communication link requiring the one or more temporary dedicated channels. Note that the plurality of channels may be within one frequency band (e.g., 60 GHz, etc.) or span several frequency bands (e.g., 60 GHz to 120 GHz, etc.).

At step 58, the configuration module 12 determines whether one or more of the wireless communication links requires a temporary shared channel of the plurality of channels. For example, when the data rate is short bursts of high rate data or low rate data, the communication resource can be shared. If the one or more of the wireless communication links requires the temporary shared channel, the method continues at step 60 where the configuration module 12 allocates division multiple access slots (e.g., TDMA slots, FDMA slots, CDMA slots, OFDM slots, etc.) of the temporary shared channel to the another one or more of the wireless communication links.

As an example, assume that the functional blocks are configured to implement a microprocessor core that includes a data register, an instruction register, and an arithmetic logic unit (ALU), which performs basic mathematical functions and logic functions. As such, communication links would need to be established between the functional blocks forming the ALU, the functional blocks forming the data register, the functional blocks forming the instruction register, between the data register and the ALU, and between the instruction register and the ALU.

Continuing with this example, some of the communication resources would be temporarily dedicated to support communication links and others would be temporarily shared to support other communication links. For instance, the communication link between the data register and the ALU may be allocated a temporarily dedicated communication resource, or resources, and the link between the instruction register and the ALU may be allocated a shared communication resource.

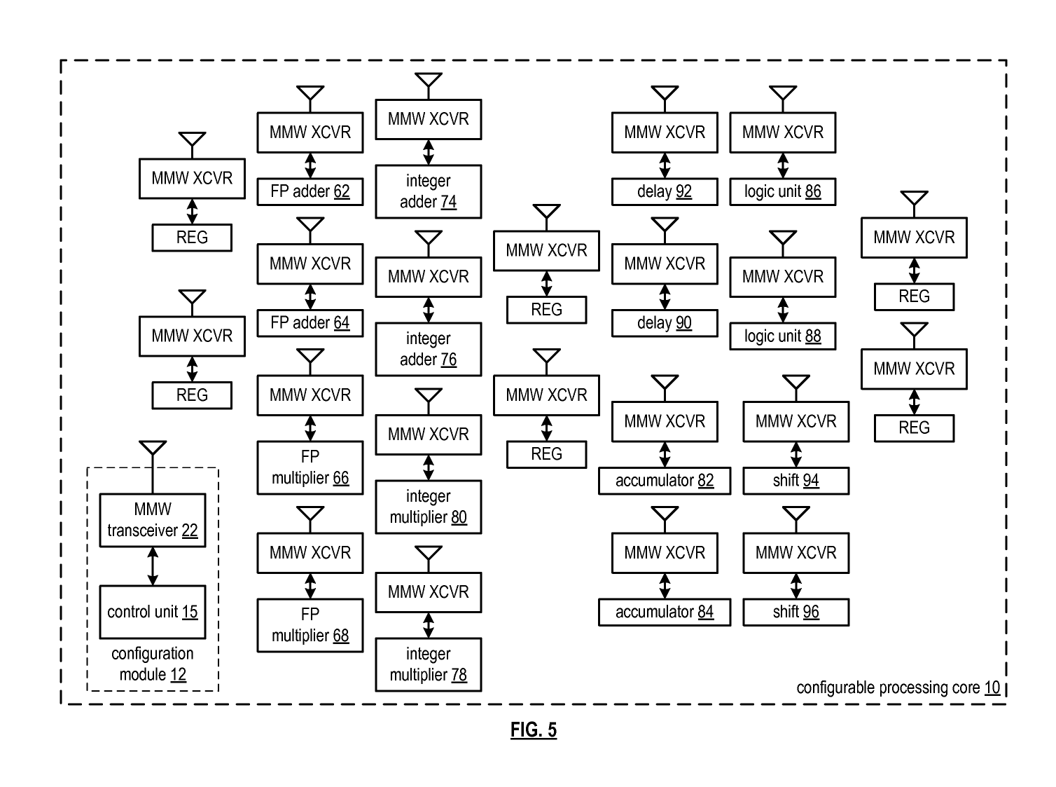

FIG. 5 is a schematic block diagram of another embodiment of a configurable processing core 10 that includes the configuration module 12 and a plurality of functional modules. The configuration module 12 includes a control unit 15 and a MMW transceiver 22. The control unit 15 may be a single processing device or a plurality of processing devices. Such a processing device may be a micro-controller, field programmable gate array, programmable logic device, state machine, logic circuitry, analog circuitry, digital circuitry, and/or any device that manipulates signals (analog and/or digital) based on hard coding of the circuitry and/or operational instructions. The control unit 115 may further include an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information.

Each of the functional blocks includes a functional circuit and an associated MMW transceiver (MMW XCVR). The functional circuits include registers (REG), floating point (FP) adders 62-64, FP multipliers 66-68, integer adders 74-76, integer multipliers 78-80, accumulators 82-84, logic units 86-88 (e.g., simple logic circuits such as AND, OR, etc., complex logic circuits implemented to execute one or more Boolean equations, etc.) delays 90-92 (e.g., delay line, delay circuit, etc.), and/or shift registers 94-96 (e.g., shift left, shift right, barrel shifter, etc.). Note that more or less functional blocks may be included in the configurable processing core 10 and may further include additional functional blocks that perform a specific function and/or a programmable function.

In general, the configuration module 12, via the control unit 15, generates a configuration signal and transmits it via the MMW transceiver 22 to the MMW transceivers of the functional blocks. Upon receipt of the configuration signal, each MMW transceiver of the functional blocks determines whether it is addressed in the configuration signal. If not, the MMW transceiver ignores the signal. If it is addressed, the MMW transceiver establishes one or more wireless communication links with one or more other MMW transceivers of different functional blocks. In this manner, at least some of the plurality of register modules, the plurality of adder modules, the plurality of multiplier modules, the plurality of shift registers, and the other functional blocks are configured to execute an instruction of an algorithm.

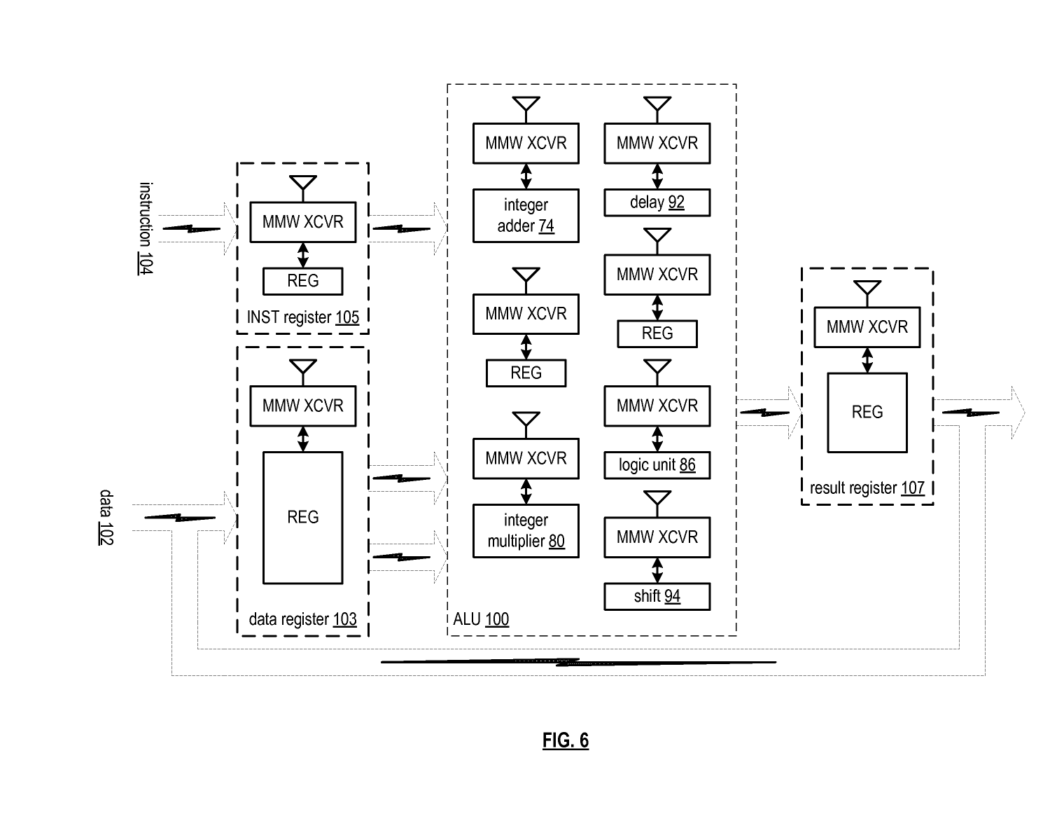

FIG. 6 is a schematic block diagram of another embodiment of a configurable processing core that is configured to provide a single microprocessing core that includes an instruction register section 105, a data register section 103, an arithmetic logic unit (ALU) section 100, and a resultant register section 107. In this embodiment, the configuration module 12 (not shown) generates a configuration signal for more or more instructions of an algorithm, which causes one or more register functional blocks to provide the instruction register section 105, one or more other register functional blocks to provide the data register section 103, one or more different register functional blocks to provide the resultant register section 107, and one or more functional blocks to provide the ALU section 100. In this example, the ALU section 100 includes one or more integer adders 74, one or more integer multipliers 80, one or more logic units 86, one or more delays 92, and/or one or more shifters 94. Note, however, that the ALU section 100 may include more or less function blocks and/or may include different functional blocks.

In this embodiment, the configuration module 12 may allocation one channel for retrieving the instruction 104 (or a plurality of instructions) from an instruction memory (not shown) and may allocation another channel for retrieving the data 102 (or a plurality of data elements) from a data memory (not shown). Alternatively, if the instruction 104 and the data 102 are stored in the same memory (e.g., a single memory device includes the instruction memory and the data memory), then the configuration module 12 may allocation a single channel for their retrieval.

The MMW transceiver of the instruction register section 105 receives the instruction 104 as a MMW signal, which it converts to a baseband or near baseband symbol stream. The baseband processing module of the MMW transceiver recovers the instruction 104 from the baseband or near baseband symbol stream and causes the recovered instruction 104 (or instructions) to be stored in the associated register (or registers).

The MMW transceiver of the data register section 103 receives the data 102 as a MMW signal, which it converts to a baseband or near baseband symbol stream. The baseband processing module of the MMW transceiver recovers the data 102 from the baseband or near baseband symbol stream and causes the recovered data 102 (or plurality of data elements) to be stored in the associated register (or registers).

As the instruction, or instructions, is being stored, or prior thereto, the configuration module 12 allocates wireless communication resources to support the operation, or operations, to be performed by the ALU section 100 for storing the resultant in the resultant register section 107. For example, if the instruction includes a command to add two values, a wireless communication link is needed from the data register section 103 to an adder (e.g., adder 74) and another wireless communication link is needed to write the resultant to the resultant register section 107. Such a process utilizes instruction by instruction interpretation and configuration.

As an alternative example, the configuration module 12 may generically configure the ALU section 100 to execute the instructions of an algorithm based on the algorithm. In this instance, the configuration module 12 would allocate wireless communication resources to support a wireless link between the instruction register section 105 and the ALU 100, a wireless link between the data register section 103 and the ALU 100, and a wireless link between the resultant register section 107 and the ALU 100. In addition, the configuration module 12 would allocate communication resources to support wireless links within the ALU 100 such that the functional blocks of the ALU are wirelessly connected to perform a variety of ALU functions.

Regardless of whether the ALU 100 is configured on a per instruction basis or generically, the MMW transceiver of the data register section 103 provides, via a MMW signal, the data 102 to the MMW transceiver of one or more functional blocks of the ALU section 100 and the MMW transceiver of the instruction register section 105 provides, via a MMW signal, the instruction to the MMW transceiver of the one or more functional blocks of the ALU 100. The MMW transceiver of the one or more functional blocks recovers the instruction 104 and the data 102 from the received MMW signals and provides the recovered instruction 104 and the recovered data 102 to the one or more functional blocks.

After the one or more functional blocks performs it function (e.g., add, multiply, shift, delay, etc.), the functional block provides its output to the associated MMW transceiver, which converts the resultant into a MMW signal that is transmitted to the MMW transceiver of another functional block or the resultant register section 107.

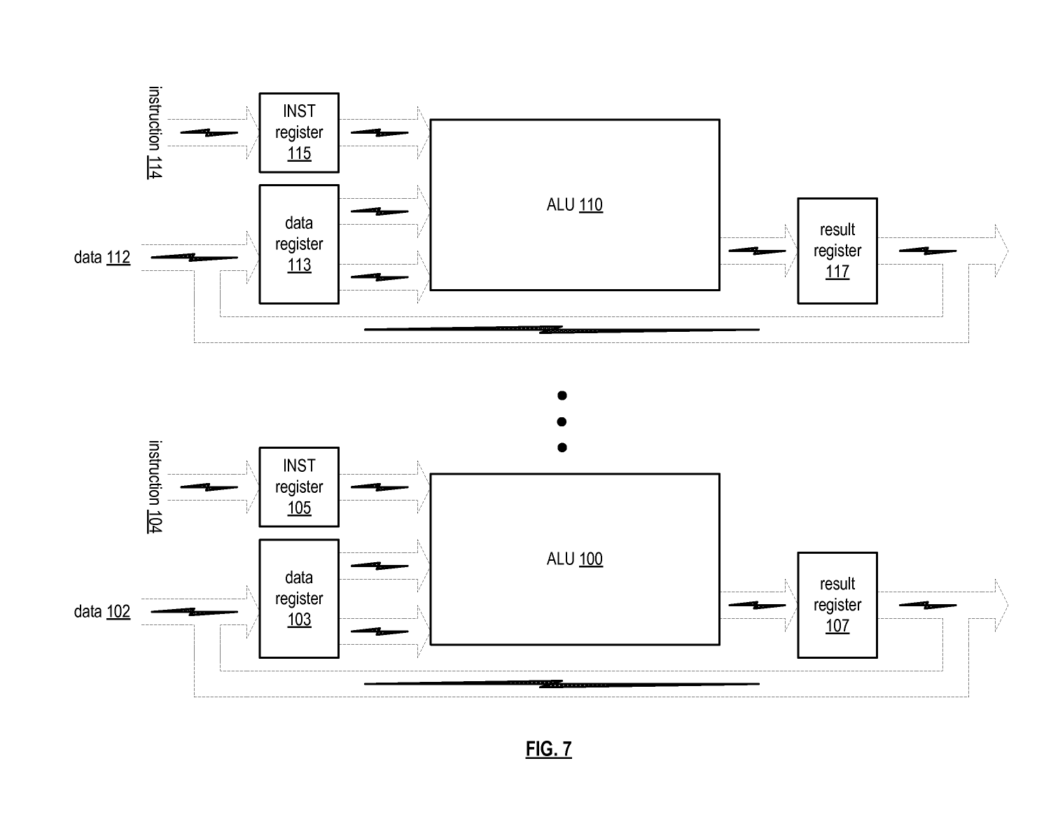

FIG. 7 is a schematic block diagram of another embodiment of a configurable processing core that is configured to provide a multiple parallel microprocessing core that includes the single microprocessing core of FIG. 6 plus one or more other microprocessing cores. The single microprocessing core of FIG. 6 includes the instruction register section 105, the data register section 103, the arithmetic logic unit (ALU) section 100, and the resultant register section 107. The one or more other microprocessing cores includes an ALU section 110, a data register section 113, an instruction register section 115, and a resultant register section 117.

In this embodiment, the ALU section 110 may be substantially the same as ALU section 100 or it may be configured in a different manner. The data register section 113, the instruction register section 115, and the resultant register section 117 includes one or more registers and associated MMW transceivers to support their respective functions. In this manner, the configuration module 12 may support the execution of multiple algorithms simultaneously and/or different threads of an algorithm simultaneously.

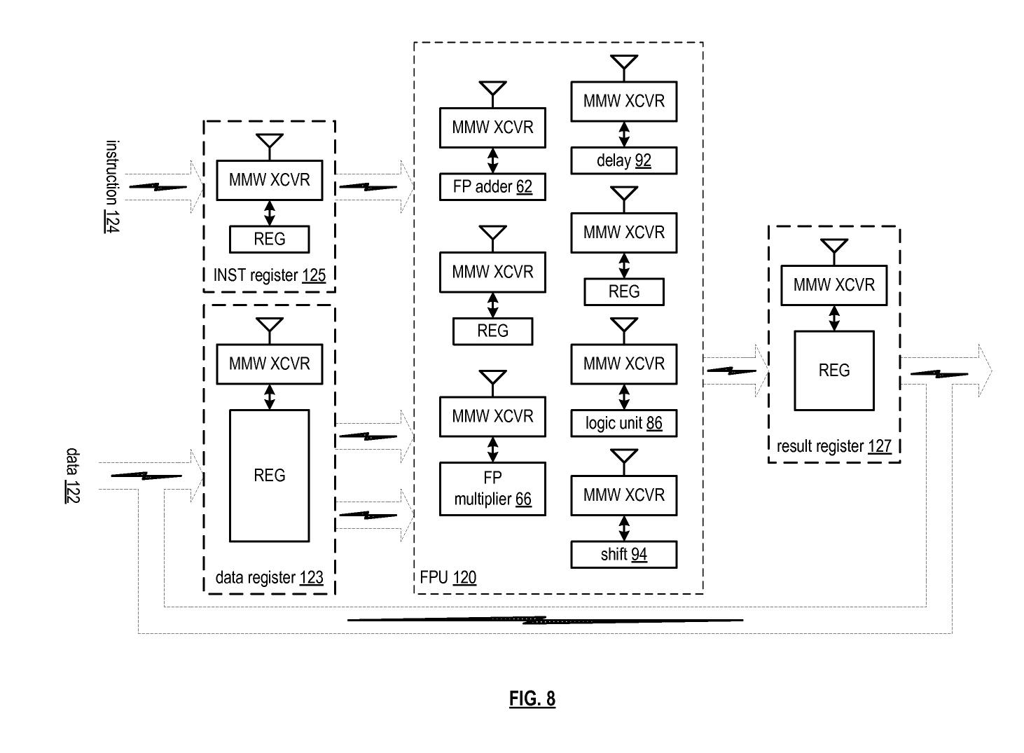

FIG. 8 is a schematic block diagram of another embodiment of a configurable processing core that is configured to provide a single floating point microprocessing core that includes an instruction register section 125, a data register section 123, a floating point unit (FPU) section 120, and a resultant register section 127. In this embodiment, the configuration module 12 (not shown) generates a configuration signal for more or more instructions of an algorithm, which causes one or more register functional blocks to provide the instruction register section 125 for storing one or more instructions 124, one or more other register functional blocks to provide the data register section 123 for storing data 122, one or more different register functional blocks to provide the resultant register section 127, and one or more functional blocks to provide the FPU section 120. In this example, the FPU section 120 includes one or more floating point adders 62, one or more floating point multipliers 66, one or more logic units 86, one or more delays 92, and/or one or more shifters 94. Note, however, that the FPU section 120 may include more or less function blocks and/or may include different functional blocks.

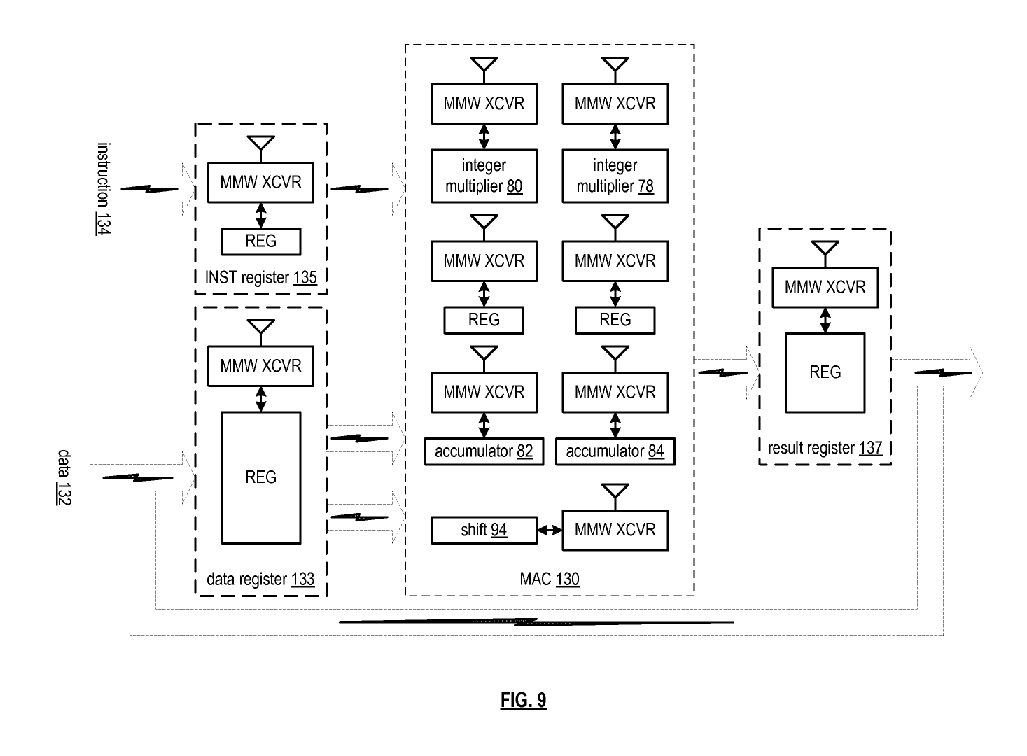

FIG. 9 is a schematic block diagram of another embodiment of a configurable processing core that is configured to provide a digital signal processing core that includes an instruction register section 135, a data register section 133, a multiply-accumulate (MAC) section 130, and a resultant register section 137. In this embodiment, the configuration module 12 (not shown) generates a configuration signal for more or more instructions of an algorithm, which causes one or more register functional blocks to provide the instruction register section 135 for storing one or more instructions 134, one or more other register functional blocks to provide the data register section 133 for storing data 132, one or more different register functional blocks to provide the resultant register section 137, and one or more functional blocks to provide the MAC section 130. In this example, the MAC section 130 includes one or more multipliers 78-80, one or accumulators 82-84, one or more shift registers 94, and/or one or more registers (REG). Note, however, that the MAC section 130 may include more or less function blocks and/or may include different functional blocks.

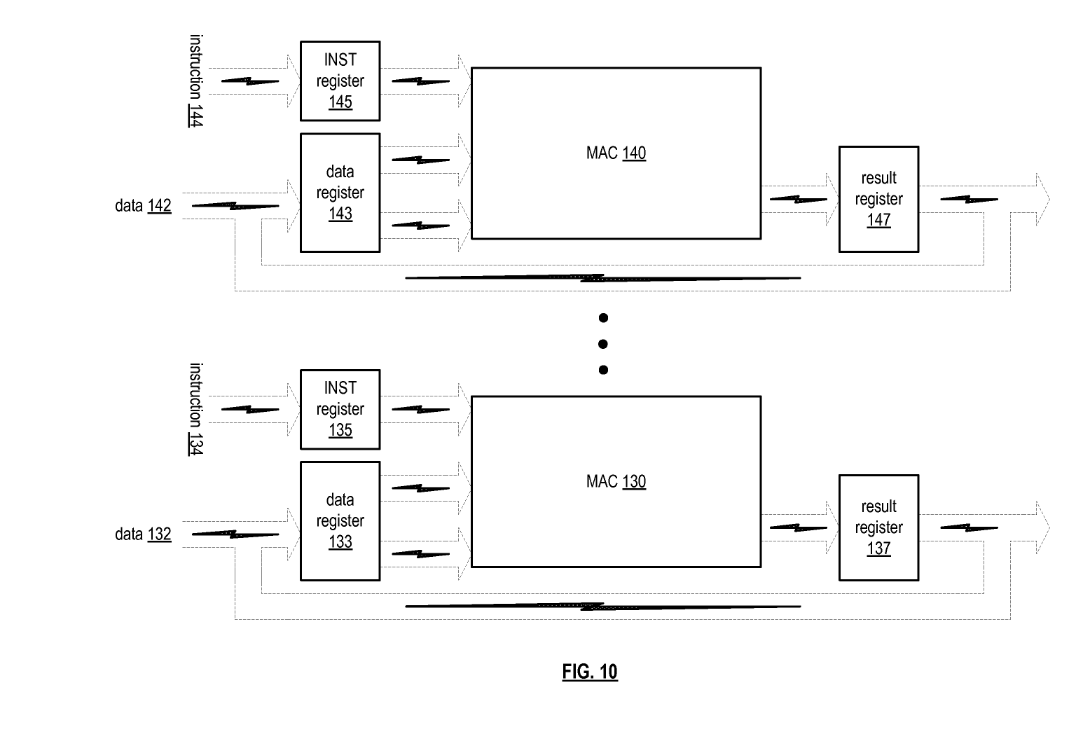

FIG. 10 is a schematic block diagram of another embodiment of a configurable processing core that is configured to provide a multiple parallel digital signal processing core that includes the single digital signal processing core of FIG. 8 plus one or more other digital signal processing cores. The single digital signal processing core of FIG. 8 includes the instruction register section 135, the data register section 133, the multiply-accumulate (MAC) section 130, and the resultant register section 137. The one or more other microprocessing cores includes an MAC section 130, a data register section 133, an instruction register section 135, and a resultant register section 137.

In this embodiment, the MAC section 140 may be substantially the same as MAC section 130 or it may be configured in a different manner. The data register section 143, the instruction register section 145, and the resultant register section 147 includes one or more registers and associated MMW transceivers to support their respective functions. In this manner, the configuration module 12 may support the execution of multiple algorithms simultaneously and/or different threads of an algorithm simultaneously.

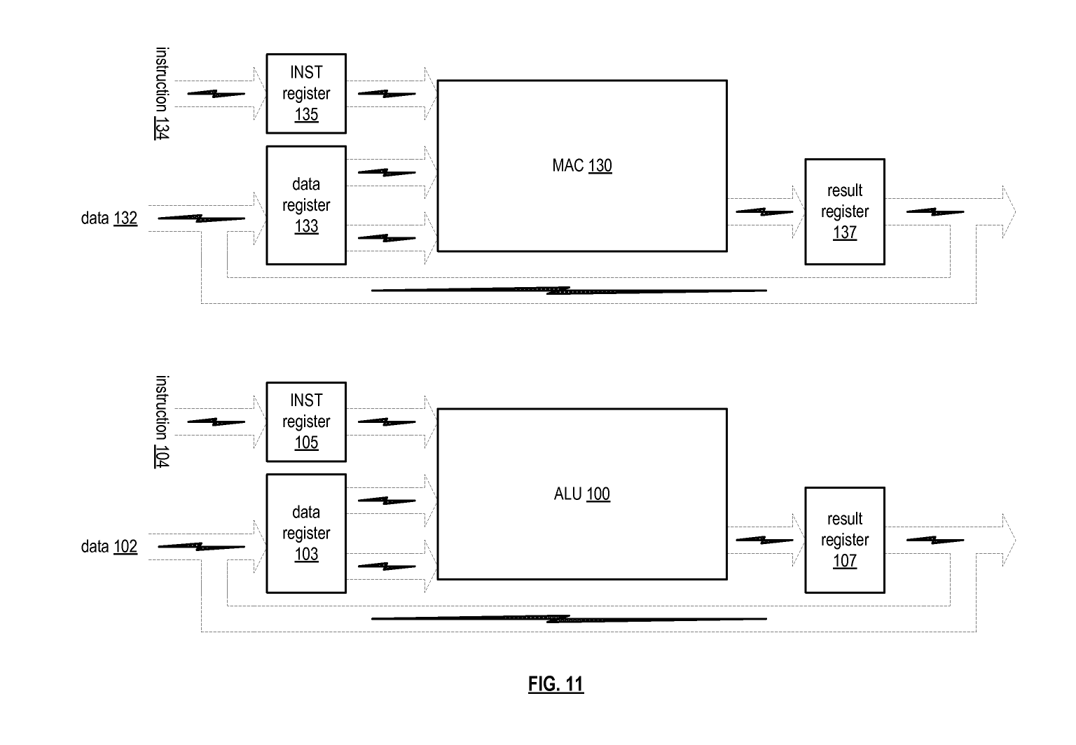

FIG. 11 is a schematic block diagram of another embodiment of a configurable processing core that includes one or more microprocessing cores and one or more digital signal processing cores. The microprocessing core includes the ALU section 100, the data register section 103, the instruction register section 105, and the resultant register section 107. The digital signal processing core includes the MAC section 130, the data register section 133, the instruction register section 135, and the resultant register section 137.

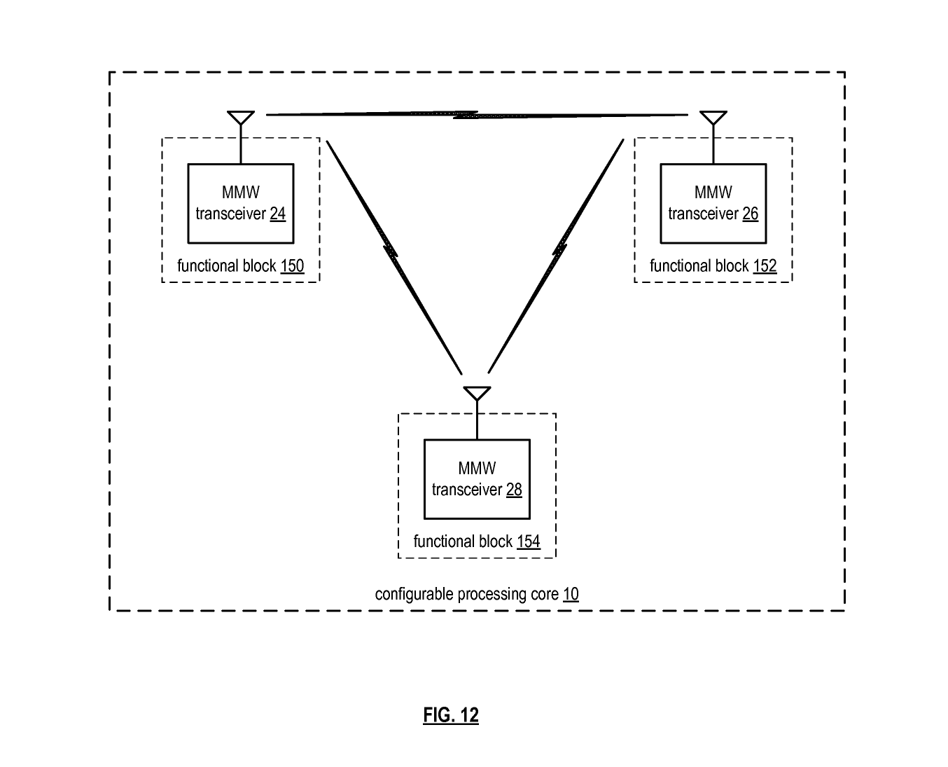

FIG. 12 is a schematic block diagram of another embodiment of a configurable processing core 10 that includes three functional blocks 150-154. Each functional block includes a MMW transceiver 24-28. Each functional block 150-154 may include one or more functional circuits that provide a floating point adder, a floating point multiplier, a register, an integer adder, an integer multiplier, a shift register, an accumulator, a logic unit, and a delay.

In this embodiment, the first, second, and third functional blocks 150-154 wireless communicate via the first, second, or third MMW transceivers 24-28 to execute at least one instruction of an algorithm. The functional blocks may receive the instruction from a control unit (not shown) via the associated MMW transceivers 24-28 and may further receive the data on which they execution the instruction via the associated MMW transceivers 24-28.

The wireless communication between the functional blocks 150-154 may be supported by dedicated wireless communication resources allocated thereto. For instance, a wireless communication resource (e.g., one or more channels, one or more division multiple access slots, etc.) is allocated to support communication between functional block 150 and functional block 152; another wireless communication resource is allocated to support communication between functional block 150 and functional block 154; and yet another wireless communication resource is allocated to support communication between functional block 152 and function block 154.

In an alternate implementation, each MMW transceiver 24-28 may allocated a separate receive communication resource. In this instance, when a functional block is to communicate with another functional block, it sets it transmit section to a frequency corresponding to the allocated receive communication resource of the other functional block. In this manner, full duplex communications can occur between the functional blocks.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A configurable processing core comprises:
a configuration module that includes a configuration millimeter wave (MMW) transceiver; and
a plurality of functional blocks, wherein each of the plurality of functional blocks includes a functional MMW transceiver and wherein:
the configuration module is operable to:
determine configuration of at least some of the plurality of functional blocks based on at least one instruction of an algorithm;
generate a configuration signal in accordance with the determined configuration; and
transmit the configuration signal to the at least some of the plurality of functional blocks via the configuration MMW transceiver and the functional MMW transceivers associated with the at least some of the plurality of functional blocks; and wherein:
the at least some of the plurality of functional blocks are operable to configure in accordance with the configuration signal to support execution of the at least one instruction.

2. The configurable processing core of claim 1, wherein the configuration module is further operable to determine the configuration of at least some of the plurality of functional blocks by:
interpreting the at least one instruction to identify the at least some of the plurality of functional blocks;
determining wireless communication links between the at least some of the plurality of functional blocks;
determining data rate requirements for each of the wireless communication links; and
allocating, when available, wireless communication resources to the wireless communication links based on the data rate requirements.

3. The configurable processing core of claim 2, wherein the configuration module is further operable to allocate, when available, the wireless communication resources by at least one of:
determining whether one or more of the wireless communication links requires one or more temporary dedicated channels of a plurality of channels, wherein the plurality of channels spans one or more frequency bands;
determining whether another one or more of the wireless communication links requires a temporary shared channel of the plurality of channels;
when the one or more of the wireless communication links requires the one or more temporary dedicated channels, allocating one or more of the plurality of channels for each wireless communication link requiring the one or more temporary dedicated channels; and
when the another one or more of the wireless communication links requires the temporary shared channel, allocating division multiple access slots of the temporary shared channel to the another one or more of the wireless communication links.

4. The configurable processing core of claim 1, wherein the plurality of functional blocks comprises two or more of:
a floating point adder;
a floating point multiplier;
a register;
an integer adder;
an integer multiplier;
a shift register;
an accumulator;
a logic unit; and
a delay.

5. The configurable processing core of claim 4, wherein the configuration module is further operable to:
generate the configuration signal to configure one or more of the floating point adder, the floating point multiplier, the register, the integer adder, the integer multiplier, the shift register, the accumulator, the logic unit, and the delay into a single microprocessing core.

6. The configurable processing core of claim 4, wherein the configuration module is further operable to:
generate the configuration signal to configure one or more of the floating point adder, the floating point multiplier, the register, the integer adder, the integer multiplier, the shift register, the accumulator, the logic unit, and the delay into a multiple parallel processing core.

7. The configurable processing core of claim 4, wherein the configuration module is further operable to:
generate the configuration signal to configure one or more of the floating point adder, the floating point multiplier, the register, the integer adder, the integer multiplier, the shift register, the accumulator, the logic unit, and the delay into a single digital signal processor core.

8. The configurable processing core of claim 4, wherein the configuration module is further operable to:
generate the configuration signal to configure one or more of the floating point adder, the floating point multiplier, the register, the integer adder, the integer multiplier, the shift register, the accumulator, the logic unit, and the delay into a multiple parallel digital signal processor core.

9. The configurable processing core of claim 4, wherein the configuration module is further operable to:
generate the configuration signal to configure one or more of the floating point adder, the floating point multiplier, the register, the integer adder, the integer multiplier, the shift register, the accumulator, the logic unit, and the delay into a parallel processor core and digital signal processor core.

10. The configurable processing core of claim 1 further comprises:
the MMW transceiver transmits the configuration signal to the function MMW transceivers of the plurality of functional blocks via a dedicate control channel.

11. A configurable processing core comprises:
a first functional block having a first millimeter wave (MMW) transceiver;
a second functional block having a second MMW transceiver; and
a third functional block having a third MMW transceiver, wherein the first, second, and third functional blocks wireless communicate with at least one other of the first, second, and third functional blocks via the first, second, or third MMW transceivers to execute at least one instruction of an algorithm.

12. The configurable processing core of claim 11 further comprises:
a configuration module that includes a configuration unit and a configuration MMW transceiver, wherein the configuration module is operable to:
interpret the at least one instruction;
determine configuration of the first, second, and third functional blocks based on the interpreting;
generate a configuration signal in accordance with the configuration of the first, second, and third functional blocks; and
transmit, via the configuration MMW transceiver, the configuration signal to the first, second, and third MMW transceivers.

13. The configurable processing core of claim 12 further comprises:
a plurality of functional blocks, wherein each of the plurality of functional blocks includes a functional circuit and a MMW transceiver; wherein the configuration module generates the configuration signal to configure at least some of the plurality of functional blocks and the first, second, and third functional blocks.

14. The configurable processing core of claim 12, wherein the plurality of functional blocks, the first, second, and third functional blocks comprises at least some of:
a floating point adder;
a floating point multiplier;
a register;
an integer adder;
an integer multiplier;
a shift register;
an accumulator;
a logic unit; and
a delay.

15. A configurable processing core comprises:
a plurality of register modules, wherein each of the plurality of register modules includes a register and a register millimeter wave (MMW) transceiver;
a plurality of adder modules, wherein each of the plurality of adder modules includes an adder and an adder MMW transceiver;
a plurality of multiplier modules, wherein each of the plurality of multiplier modules includes a multiplier and a multiplier MMW transceiver;
a plurality of shift register modules, wherein each of the plurality of shift register modules includes a shift register and a shift register MMW transceiver; and
a configuration module that includes a configuration MMW transceiver, wherein the configuration module is operable to generate a configuration signal and transmit the configuration signal via the configuration MMW transceiver, wherein at least some of the plurality of register modules, the plurality of adder modules, the plurality of multiplier modules, and the plurality of shift registers are configured in accordance with the configuration signal to execute an instruction of an algorithm.

16. The configurable processing core of claim 15 further comprises:
the plurality of multiplier modules including a plurality of floating point multipliers and a plurality of integer multipliers; and
the plurality of adder modules including a plurality of floating point adders and a plurality of integer adders.

17. The configurable processing core of claim 15 further comprises at least one of:
a plurality of accumulator modules, wherein each of the plurality of accumulator modules includes an accumulator and an accumulator MMW transceiver; and
a plurality of delay modules, wherein each of the plurality of delay modules includes a delay and a delay MMW transceiver.

18. The configurable processing core of claim 15, wherein the configuration module is further operable to:
generate the configuration signal to configure the at least some of the plurality of register modules, the plurality of adder modules, the plurality of multiplier modules, and the plurality of shift registers into a single microprocessing core.

19. The configurable processing core of claim 15, wherein the configuration module is further operable to:
generate the configuration signal to configure the at least some of the plurality of register modules, the plurality of adder modules, the plurality of multiplier modules, and the plurality of shift registers into a multiple parallel processing core.

20. The configurable processing core of claim 15, wherein the configuration module is further operable to:
generate the configuration signal to configure the at least some of the plurality of register modules, the plurality of adder modules, the plurality of multiplier modules, and the plurality of shift registers into a single digital signal processor core.

21. The configurable processing core of claim 15, wherein the configuration module is further operable to:
generate the configuration signal to configure the at least some of the plurality of register modules, the plurality of adder modules, the plurality of multiplier modules, and the plurality of shift registers into a multiple parallel digital signal processor core.

22. The configurable processing core of claim 15, wherein the configuration module is further operable to:
generate the configuration signal to configure the at least some of the plurality of register modules, the plurality of adder modules, the plurality of multiplier modules, and the plurality of shift registers a parallel processor core and digital signal processor core.
